(19) United States
(12) Patent Application Publication
(10) Pub. No.: US 2008/0292860 A1
(43) Pub. Date: Nov. 27, 2008

(54) Ultrasonic Vibration Cutting Method and a Fiber Reinforced Plastic Member Manufactured by the Method

(75) Inventor: Hukuzo Yagishita, Shizuoka (JP)

Correspondence Address: HARNESS, DICKEY & PIERCE, P.L.C., P.O. BOX 828, BLOOMFIELD HILLS, MI, 48303, US

(73) Assignee: Hamamatsu Foundation for Science and Technology Promotion, Shizuoka (JP)

(21) Appl. No.: 12/126,062

(22) Filed: May 23, 2008

Related U.S. Application Data
(63) Continuation of application No. PCT/JP2006/323433, filed on Nov. 24, 2006.

(30) Foreign Application Priority Data
Nov. 25, 2005 (JP) 2005-340945

(51) Int. Cl. B26D 1/00; B32B 27/12

(52) U.S. Cl. 428/221; 83/13

(57) ABSTRACT

An ultrasonic vibration cutting method for drilling a workpiece using a drill applied to the workpiece. Ultrasonic torsional mode vibration in its rotational direction is applied to the drill. The workpiece is a fiber reinforced plastic member including carbon fibers as its reinforcing fibers. The drilling by the drill, with the ultrasonic torsional mode vibration in its rotational direction, provides a drilled surface that is substantially smooth.

### CROSS-REFERENCE TO RELATED APPLICATIONS

This application is a continuation of International Application No. PCT/JP2006/323433, filed Nov. 24, 2006, which claims priority to Japanese Application No. 2005-340945, filed Nov. 25, 2005. The disclosures of the above applications are incorporated herein by reference.

### FIELD

The present disclosure relates to an ultrasonic vibration cutting method to drill a workpiece using a drill. Ultrasonic torsional mode vibration in a rotational direction is applied to the drill. A fiber reinforced plastic member is manufactured by the method.

### BACKGROUND

In recent years, in order to manufacture an aircraft airframe or its structural elements, fiber reinforced plastic members have been used in order to reduce the weight of the aircraft. The fiber reinforced plastic members have been provided in various forms such as those including carbon fibers, as reinforcing fibers (Carbon Fiber Reinforced Plastic: CFRP), or glass fibers, as reinforcing fibers (Glass Fiber Reinforced Plastic: GFRP), and are usually formed as a laminated body with a plurality of plastic plies. The reinforced fibers in each ply are orthogonally or obliquely intersected with reinforcing fibers in adjacent plies (see e.g. Japanese Laid-open Patent Publication No. 126557/2005).

The fiber reinforced plastic member is required to be drilled using a drill to pass a bolt etc. therethrough to connect structural elements to each other when the fiber reinforced plastic members are used for an aircraft airframe or its structural elements. However when a fiber reinforced plastic member (especially that using carbon as reinforcing fibers) is drilled with a conventional twist drill, an extremely large amount of heat is generated by cutting resistance. Thus, the smoothness of the worked (i.e. drilled) surface is extremely deteriorated. Also, the service life of the drill is extremely shortened.

Excessive cutting resistance is caused by friction between the cutting edges of the drill and reinforcing fibers. Thus, an excessive amount of heat is also generated during a drilling process of the fiber reinforced plastic member using a conventional twist drill at a region where the reinforcing fibers (e.g. carbon fibers) extend parallel to the cutting direction. The generated heat influences plastic forming the matrix (e.g. epoxy etc.) of the fiber reinforced plastic and causes undulations on the worked surface.

### SUMMARY

It is an object of the present disclosure to provide an ultrasonic vibration cutting method that improves the smoothness of a worked surface as well as the service life of a drill. This occurs by reducing the cutting resistance due to excessive friction caused during a drilling process by reinforcing fibers included in a fiber reinforced plastic member. Additionally, it is an object to provide a fiber reinforced plastic member manufactured by the method.

To achieve the object, an ultrasonic vibration cutting method drills a workpiece with a drill. Ultrasonic torsional mode vibration in its rotational direction is applied to the drill. The workpiece is a fiber reinforced plastic member including carbon fibers as reinforcing fibers.

The reinforcing fibers are included in the plastic in a knitted form, a woven form or a nonwoven fabric form.

The fiber reinforced plastic member is formed as a lamination of a plurality of plastic plies. The plurality of plastic plies are laminated so that the reinforcing fibers in each plastic ply alternately intersect, in an orthogonally or obliquely intersecting fashion, with reinforcing fibers in adjacent plastic ply.

The drill has a candle shaped cutting edge with no marginal portion slide-contacting a working surface during a drilling process.

A fiber reinforced plastic member includes carbon fibers as its reinforcing fibers. The drilling is by a drill. Ultrasonic torsional mode vibration, in its rotational direction, is applied via the drill to the plastic member. The drilled surface is substantially smooth.

The reinforcing fibers are included in the plastic ply as any one of a knitted form, a woven form or a nonwoven fabric form.

The fiber reinforced plastic member is formed as a lamination of a plurality of plastic plies. The plurality of plastic plies are laminated so that the reinforcing fibers in each plastic ply alternately intersect, in an orthogonal or oblique intersecting fashion, with reinforcing fibers in adjacent plastic ply in an orthogonal or oblique intersecting fashion.

The drill has a candle shaped cutting edge with no marginal portion slide-contacting a working surface during a drilling process.

The drill that ultrasonic torsional mode vibration, in its rotational direction, is applied, is used when a fiber reinforced plastic member, including carbon fibers as its reinforcing fibers, is drilled. Thus, it is possible to improve the smoothness of a worked surface as well as the service life of the drill by reducing the cutting resistance due to excessive friction caused during the drilling process by the reinforcing fibers in the fiber reinforced plastic member.

The drill has a candle shaped cutting edge with no marginal portion slide-contacting a working surface during the drilling process. Thus, it is possible to further suppress the cutting resistance due to excessive friction caused during the drilling process. Thus, this obtains a smoother worked surface and improves the service life of the drill.

The fiber reinforced plastic member, including carbon fibers as reinforcing fibers, is drilled by a drill. Ultrasonic torsional mode vibration, in its rotational direction, is applied, via the drill, to the member. The drilled surface is substantially smooth. Thus, it is possible to apply the fiber reinforced plastic member to an aircraft airframe or to connecting portions of its structural elements.

The drill has a candle shaped cutting edge with no marginal portion slide-contacting a working surface during the drilling process. Thus, it is possible to further suppress the cutting resistance due to excessive friction caused during the drilling process and to apply the fiber reinforced plastic member to an aircraft airframe or to connecting portions of its structural elements.

Further areas of applicability will become apparent from the description provided herein. It should be understood that the description and specific examples are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1 is a schematic view of an ultrasonic torsional mode vibration cutting apparatus of a preferred embodiment.

FIG. 2 is a schematic cross sectional view of an inside arrangement of the ultrasonic torsional mode vibration cutting apparatus of FIG. 1.

FIG. 3 a side elevation view of a twist drill used in the ultrasonic torsional mode vibration cutting apparatus of FIG. 1.

FIG. 4(a) is an enlarged front elevation view showing the twist drill of FIG. 3.

FIG. 4(b) is a partially enlarged side elevation view near a tip of the twist drill of FIG. 3.

FIG. 5 is a schematic cross sectional view of a fiber reinforced plastic (CFRP) member to which the method of the present disclosure is applied.

FIG. 6 is explanatory view for explaining a relation between the cutting direction of the twist drill and the extending direction of the reinforcing member.

FIG. 6(a) shows that the reinforcing fibers extend in a left-right direction of the drawing.

FIG. 6(b) shows that the reinforcing fibers extend in an up-down direction of the drawing;

FIG. 7(a) is an explanatory view showing the cutting speed of the circumferential cutting edge of twist drill in relation to time.

FIG. 7(b) is an explanatory view showing the cutting resistance applied to the twist drill in relation to time used in the ultrasonic torsional mode vibration cutting apparatus of FIG. 1.

FIG. 8 is a graph showing results of experiment for comparing an amount of wear between the present disclosure and a comparative example.

FIG. 9 is a graph showing results of experiment for comparing a service life of a carbide fiber drill between the present disclosure and a comparative example.

### DETAILED DESCRIPTION

A preferred embodiment of the present disclosure will be hereinafter described with reference to accompanied drawings.

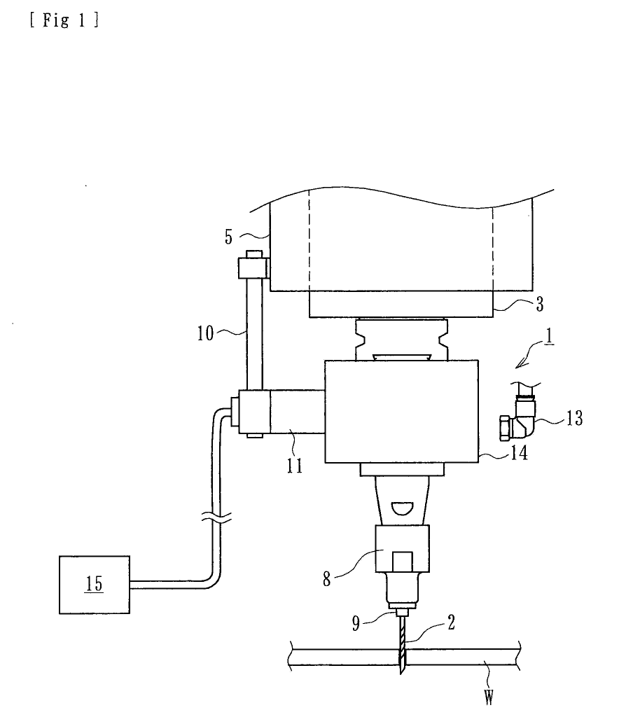

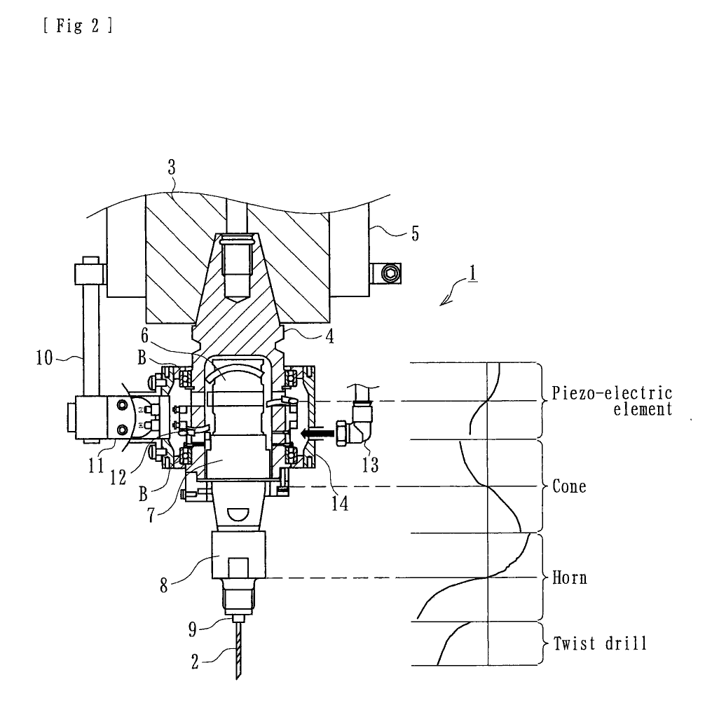

As shown in FIGS. 1 and 2, the cutting apparatus used in the ultrasonic vibration cutting method of the present disclosure is an ultrasonic torsional mode vibration cutting apparatus 1 for drilling a workpiece “W” using a twist drill 2. The ultrasonic torsional mode vibration is applied to the drill 2 in its rotational direction. This apparatus includes a rotary side base 3, within a secured side base 5, a rotary member 4, a piezo-electric element 6, a cone 7, and a horn 8.

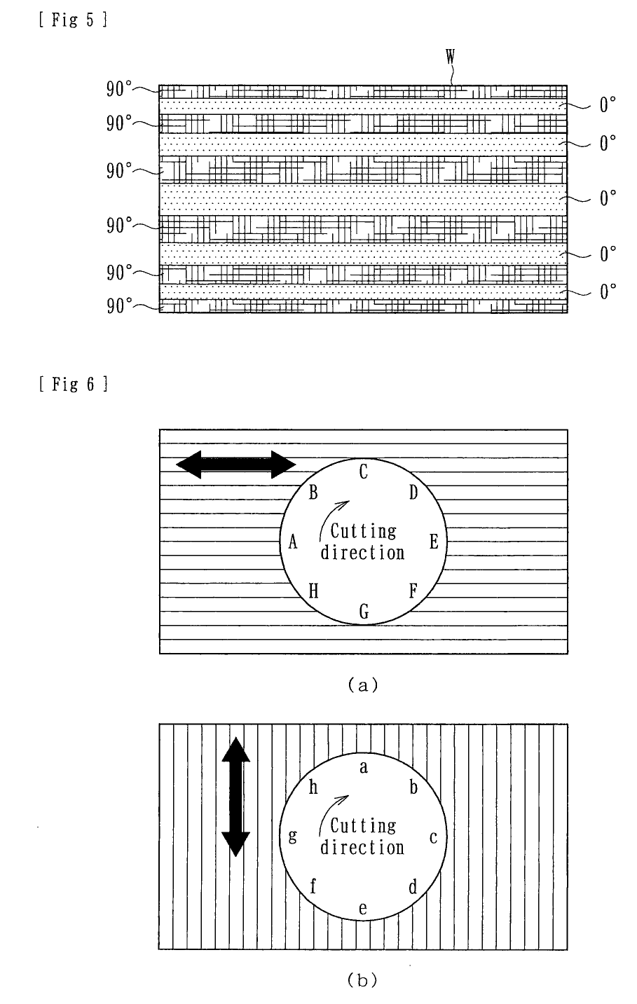

The workpiece “W” is a carbon fiber reinforced plastic (CFRP) member with a lamination of a plurality of plastic plies. Each ply includes carbon fibers as its reinforcing fibers. As shown in cross section in FIG. 5, the fiber reinforced plastic member includes a plurality of plastic plies. The included reinforcing fibers in each ply are arranged so that they alternately intersect, orthogonally (i.e. at 90°) or obliquely, with reinforcing fibers in an adjacent ply. The reinforcing fibers may be included in the plastic ply as any one of a knitted form, a woven form or a nonwoven fabric form.

The carbon fiber reinforced plastic (CFRP) member is manufactured by making a sheet shaped prepreg where the carbon reinforced fibers are included in a thermosetting resin such as epoxy. Then after having laminated a plurality of prepreg sheets with the extending direction of the reinforcing fibers being differentiated, the carbon fiber reinforced plastic (CFRP) member is finished by heating and pressurizing the laminated prepreg sheets. It should be noted that the present disclosure may be applied to a fiber reinforced plastic of multi plies or also a mono ply, however it is preferable in a mono ply that the reinforcing fibers is in the knitted form or the woven form.

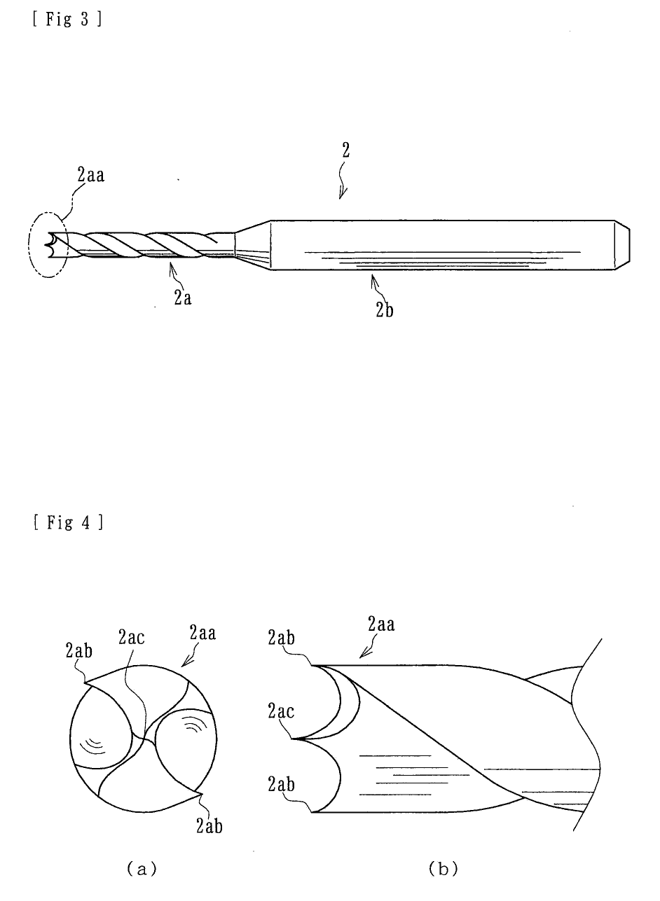

The ultrasonic torsional mode vibration cutting apparatus of the present disclosure that performs the drilling process at a predetermined position in the carbon fiber reinforced plastic (CFRP) member is shown by 1 (FIG. 1 and FIG. 2). The apparatus has a rotary side base 3 adapted to be rotated in a predetermined direction by a driving source (not shown). The rotary member 4 is connected to the bottom of the rotary side base 3. The piezo-electric element 6 generates the ultrasonic torsional mode vibration. The cone 7 amplifies the torsional vibration and transmits it to the twist drill 2. The piezo-electric element 6 and cone 7 are arranged within the rotary member 4. The torsional vibration transmitted to the cone 7 and horn 8 is amplified mechanically by themselves. A collet chuck 9 is connected to the bottom end of the horn 8 and a shank 2b (FIG. 3) of the twist drill 2 is adapted to be secured to the collet chuck 9.

An arm 10 extends downward from the secured side base 5. A securing member 11 is mounted on the bottom end of the arm 10. The securing member 11 holds a supporting member 14 where the rotary member 4 can be rotated. The supporting member 14 covers the outer circumferential surface of the lower portion of the rotary member 4. That is, the rotary member 4 is rotationally supported by a bearing “B” with its outer race secured on the supporting member 14 and its inner race secured on the rotary member 4.

Brushes 12 are mounted within the supporting member 14. They extend toward the piezo-electric element 6. Electric power is supplied to the piezo-electric element 6 from a power source via the brushes 12. This enables the electric power to be supplied to the rotating piezo-electric element 6. A numeral 13 in FIG. 2 denotes an air blowing out mechanism to blow out air into the inside of the supporting member 14 to cool it.

As shown in FIGS. 3 and 4, the twist drill 2 is a carbide fiber drill made of cemented carbide including a body 2a and the shank 2b. A tip end 2aa of the body 2a of the twist drill 2 is a so-called candle shaped cutting edge. It includes a pair of cutting edges 2ab projecting from its circumferential edge and a chisel edge 2ac, projecting longer than the cutting edges 2ab, at its center.

The twist drill 2 does not include any marginal portion that is normally formed on a conventional twist drill and adapted to be in slide-contacted with a drilled surface during the drilling process. It is preferable to apply a wear resistant coating on the surface of the twist drill 2 to extend its service life. The web thinning is applied on the chisel edge 2ac to reduce a thrust load during the drilling process.

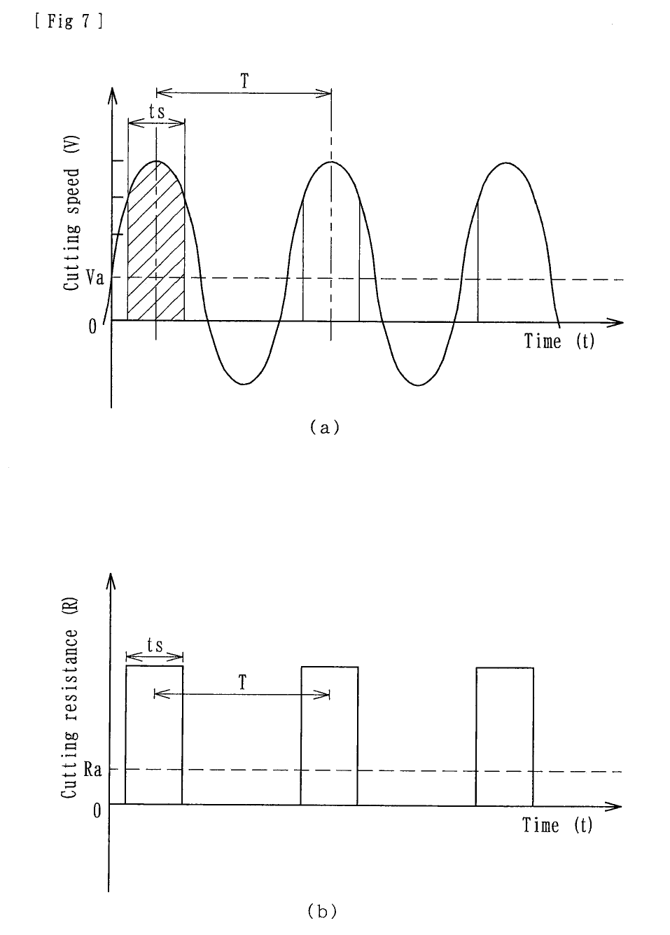

According to the ultrasonic torsional mode vibration cutting apparatus 1 of the present disclosure, the ultrasonic torsional mode vibration generated by the piezo-electric element 6 and amplified by cone 7 and the horn 8 is applied to the twist drill 2 by the driving force from the rotary side base 3. In more detail, the ultrasonic torsional mode vibration of a predetermined frequency “f” is applied to the twist drill 2 rotating at a rotational speed Va and accordingly the cutting is executed at an instantaneous cutting speed “V” (=Va+2πfa·cos 2πf·t) as shown in FIG. 7.

Actual cutting by the twist drill 2 is executed only during a time period “ts” shown by hatching in FIG. 7(a). Thus an intermittent cutting of time period “ts” is executed microscopically. Accordingly, it will be understood that the cutting speed “V” in the actual cutting time period “ts” becomes remarkably high and thus a large amount of cutting can be obtained instantaneously. On the other hand, as shown in FIG. 7(b), although the cutting resistance becomes large during actual cutting time period “ts”, the equalized cutting resistance over one period drilling T becomes “Ra”, and thus it will be understood that drilling with a relatively small cutting resistance is possible.

Accordingly, it is possible to reduce the excessive cutting resistance caused by the presence of the reinforcing fibers (carbon fibers) included in the fiber reinforced plastic member. Additionally it is possible to suppress the heat generated by executing the drilling of the fiber reinforced plastic with use of the twist drill 2, where the ultrasonic torsional mode vibration, in its rotational direction, is applied, in accordance with the present disclosure. In addition, according to the twist drill 2 of the present disclosure, a large amount of cutting can be obtained instantaneously. Thus, the time period for the cutting edge of the twist drill 2 to slide in contact with the reinforcing fibers is shortened in places where the extending direction of the reinforcing fibers and the cutting direction of the twist drill 2 are substantially parallel with each other. Accordingly, it is possible to execute excellent cutting of the reinforcing fibers while suppressing the frictional resistance.

As shown in FIG. 6, when a conventional twist drill of the prior art is used, excessive heat is generated by excessive cutting resistance due to friction during the cutting process at positions shown by reference characters “C” and “G” in FIG. 6(a) as well as “c” and “g” in FIG. 6(b) where the cutting direction is substantially parallel to the extending direction of reinforcing fibers. Accordingly, undulations such as craters would be created on the worked surface of the matrix of the fiber reinforced plastic at positions shown by reference characters “D” and “H” in FIG. 6(a) as well as “d” and “h” in FIG. 6(b) where the cutting direction is substantially 45° relative to the extending direction of reinforcing fibers. However, such a problem is solved by the present disclosure.

Thus according to the present disclosure it is possible to improve the accuracy and the smoothness of the drilled surface in the fiber reinforced plastic. Also, it is possible to improve the service life of a drill due to the excessive heat caused by the cutting resistance due to excessive friction. In addition, since the twist drill 2 used in the ultrasonic torsional mode vibration cutting apparatus 1 of the present disclosure is devoid of any marginal portion slide-contacting a drilled surface during a drilling process, it is possible to more effectively reduce the cutting resistance due to friction and thus to suppress the generation of heat during the drilling process.

Accordingly, it is possible to obtain a fiber reinforced plastic member with a substantially smooth worked surface by drilling the fiber reinforced plastic member using the twist drill 2, while applying ultrasonic torsional mode vibration in its rotational direction. The fiber reinforced plastic member obtained by such a way can be used on aircraft airframes or its structural elements and applied to bore apertures for fastening.

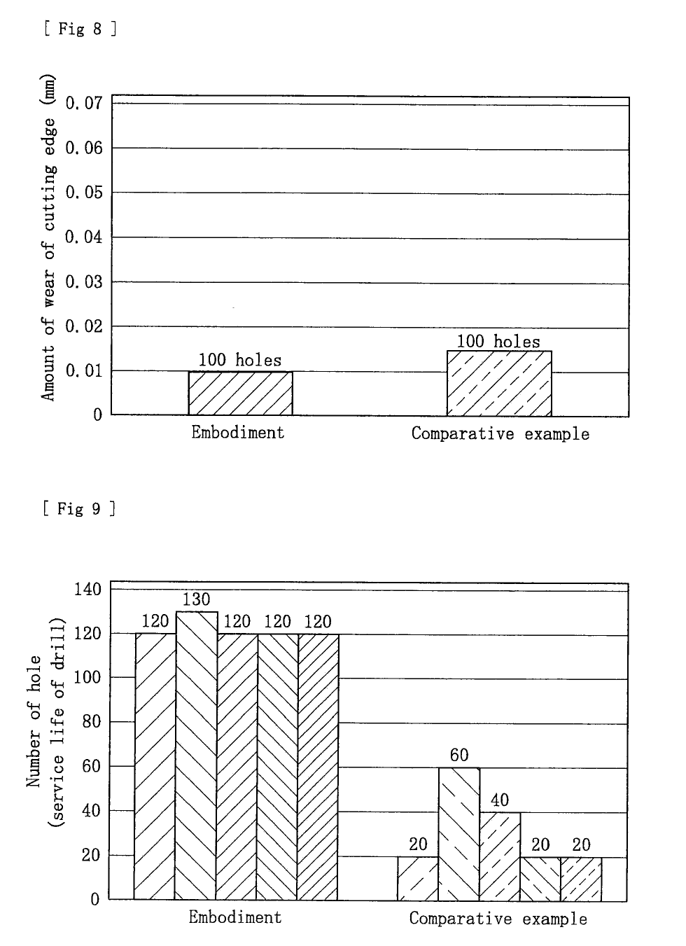

Experiments obtained by comparing a case where the drilling was executed by using the ultrasonic torsional mode vibration cutting apparatus of the present disclosure (shown by “Embodiment” in FIGS. 8 and 9) with a case where drilling was performed by using a drill without applying any ultrasonic torsional mode vibration “Comparative example” is shown in FIGS. 8 and 9. The drills used in either case are carbide fiber drills with a 3 mm diameter with the same shape and material etc.

FIG. 8 shows results obtained by measuring an amount of wear (mm) of the cutting edge of drills after having drilled 100 holes in a carbon fiber reinforced plastic sheet (thickness: 4.3 mm). It is apparent that the amount of wear is reduced in the present “Embodiment” compared with the “Comparative example”.

FIG. 9 shows results of the number of hole drilled by five drills respectively in the present “Embodiment” and the “Comparative example” and executing the drilling until the service life of drills has expired. It is apparent that the service life of drills in “Comparative example” is ½˜⅙of that in the present “Embodiment”. Thus, the present disclosure reduces the amount of wear on the cutting edge of the drills during drilling the process and improves the service life of drills.

The present disclosure can be applied to structural elements other than the aircraft airframes and its structural elements if the drill used is one applied with the ultrasonic torsional mode vibration in its rotational direction. The fiber reinforced plastic used is one where the worked surface, drilled surface, is substantially smooth.

Although the present disclosure has been described with reference to the preferred embodiment, the present disclosure is not limited to the illustrated explanations. For example, other types of drills (e.g. those having marginal portions or those having cutting edges of not a so-called “candle shape”) may be used in place of the twist drill. The fiber reinforced plastic member to be drilled may be various kinds of fiber reinforced plastic member different in material of matrix, or types and directions of included reinforcing fibers.

What is claimed is:

1. An ultrasonic vibration cutting method for drilling a workpiece comprising:
applying a drill to a workpiece;
apply ultrasonic torsional mode vibration, in its rotational direction to said drill;
drilling said workpiece which is a fiber reinforced plastic member including carbon fibers as its reinforcing fibers.

2. The ultrasonic vibration cutting method of claim 1 wherein said reinforcing fibers included in said plastic are in a knitted form, a woven form or a nonwoven fabric form.

3. The ultrasonic vibration cutting method of claim 1 wherein said fiber reinforced plastic member is formed as a lamination of a plurality of plastic plies, said plurality of plastic plies are laminated so that said reinforcing fibers, in each plastic ply, alternately intersect in an orthogonally or obliquely intersecting fashion with reinforcing fibers in an adjacent plastic ply.

4. The ultrasonic vibration cutting method of claim 1 wherein the drill has a candle shaped cutting edge with no marginal portion slide-contacting a drilled surface during the drilling process.

5. A fiber reinforced plastic member including carbon fibers as reinforcing fibers and drilled by a drill, that is applied with ultrasonic torsional mode vibration in its rotational direction, comprising a drilled surface that is substantially smooth.

6. The fiber reinforced plastic member of claim 5 wherein said reinforcing fibers included in said plastic ply are in any one of a knitted form, a woven form or a nonwoven fabric form.

7. The fiber reinforced plastic member of claim 5 wherein said fiber reinforced plastic member is formed as a lamination of a plurality of plastic plies, and said plurality of plastic plies are laminated so that said reinforcing fibers in each plastic ply alternately intersect in an orthogonally or obliquely intersecting fashion with reinforcing fibers in an adjacent plastic ply.

8. The fiber reinforced plastic member of claim 5 wherein said drill has a candle shaped cutting edge with no marginal portion slide-contacting a drilled surface during a drilling process.
